(19) United States
(12) Patent Application Publication
(10) Pub. No.: US 2011/0180147 A1
(43) Pub. Date: Jul. 28, 2011

(54) METHOD AND APPARATUS FOR IMPROVED SOLENOID VALVES

(75) Inventor: Graham David Josland, Cheshire (GB)

(73) Assignee: THERMO FISHER SCIENTIFIC INC., Sugar Land, TX (US)

(21) Appl. No.: 12/695,624

(22) Filed: Jan. 28, 2010

(51) Int. Cl. F16K 31/02; B23P 23/00

(52) U.S. Cl. 137/1; 251/129.21; 29/401.1

(57) ABSTRACT

An apparatus for controlling fluid flow including a solenoid valve. The solenoid valve includes a valve body located outside an instrumentation enclosure, wherein the valve body includes at least one connection port for controlling fluid flow and a valve plunger housing located within the instrumentation enclosure, wherein a solenoid coil is wound around the valve plunger housing portion. The apparatus also includes an instrumentation enclosure wall including an aperture through which the valve plunger housing is inserted into the instrumentation enclosure.

### BACKGROUND

1. Field of the Disclosure

Embodiments disclosed herein relate generally to an apparatus and method for using solenoid valves to control fluid flow in hazardous areas. More specifically, embodiments disclosed herein relate to using solenoid valves with instrumentation enclosures to control fluid flow in hazardous areas.

2. Background Art

Instrument enclosures such as gas analyzers, gas sample handling systems, and other gas condition equipment are often required to operate in hazardous areas. A hazardous area is defined as a place where concentrations of flammable gases, vapors, or dusts may occur. Electrical equipment that must be installed in such locations is especially designed and tested to ensure it does not start an explosion, due to arcing contacts or high surface temperature of equipment.

A common method to prevent explosions/ignitions from the exposure of flammable gases with the air surrounding the instrument enclosure is known as pressurization and purge. Equipment enclosures can be pressurized with clean air or an inert gas, and interlocked so that the equipment is disconnected or an alarm is raised (depending on the hazard rating of the area) if the pressurizing gas supply fails. In the pressurization and purge method, the instrument enclosure is maintained under a positive atmospheric pressure to preventingress of the external, potentially explosive, atmosphere, which could otherwise be ignited by the instrumentation. Where the normal function of the instrumentation requires that flammable gas is introduced into the enclosure, the pressurizing gas may also be used to apply a continuous purge to the enclosure to dilute any possible internal leak (source of release) to a safe level.

In some cases, the instrumentation involved requires control of the flow of gases or liquids using valves. For example, selection calibration or process samples for a gas analyzer require the control of the flow of gases. One method for explosion protection of such instrumentation that involves the flow of gases/liquids is to provide direct control of the gases/liquids using general purpose solenoid valves. Solenoid valves are placed either completely within the enclosure or completely outside of the enclosure. When the solenoid valve is placed completely within the enclosure, the valve falls within the pressurized envelope and thus does not directly ignite the external explosive atmosphere. However, in the case in which the fluid being controlled is itself flammable, the fluid may leak within the enclosure from the valve and/or associated connections of the valve to the enclosure. When the solenoid valve is placed outside of the enclosure, the valves must be safe for operation in hazardous areas. Flameproof or intrinsically safe solenoid valves may be used for this purpose. Alternatively, general purpose solenoid valves within the enclosure may be used to switch compressed air, which in turn operates pneumatically controlled valves outside the enclosure.

Accordingly, there exists a need for using general-purpose solenoid valves with an instrumentation enclosure operating in a hazardous area while posing minimal risk of ignition.

### SUMMARY

In general, in one aspect, the invention relates to an apparatus for controlling fluid flow, comprising a solenoid valve, comprising a valve body located outside an instrumentation enclosure, wherein the valve body comprises at least one connection port for controlling fluid flow and a valve plunger housing located within the instrumentation enclosure, wherein a solenoid coil is wound around the valve plunger housing portion, and an instrumentation enclosure wall comprising an aperture through which the valve plunger housing is inserted into the instrumentation enclosure.

In general, in one aspect, the invention relates to a method for using a solenoid valve in a hazardous area comprising an instrumentation enclosure, the method comprising controlling fluid flow using the solenoid valve, wherein the solenoid valve comprises a valve body located in the hazardous area, and a valve plunger housing around which a solenoid coil is wound, wherein the valve body comprises at least one connection port for controlling fluid flow and is located outside the instrumentation enclosure in the hazardous area, and wherein the valve plunger housing and the solenoid coil are located within the instrumentation enclosure.

In general, in one aspect, the invention relates to a method for retrofitting a solenoid valve comprising a valve body portion and a valve plunger housing portion around which a solenoid coil is wound, to operate in a hazardous area comprising an instrumentation enclosure, the method comprising creating an aperture in an enclosure wall of the instrumentation enclosure, removing the solenoid coil from the solenoid valve, reassembling the solenoid coil through the enclosure wall, wherein reassembling the solenoid coil through the enclosure wall comprises inserting the valve plunger housing portion through the hole of the enclosure wall, placing the valve body portion outside the instrumentation enclosure in the hazardous area, and reattaching the solenoid coil to the valve plunger housing portion located inside the instrumentation enclosure.

Other aspects of the invention will be apparent from the following description and the appended claims.

### BRIEF DESCRIPTION OF DRAWINGS

Embodiments disclosed herein relate generally to an apparatus and method for using solenoid valves to control fluid flow in hazardous areas. More specifically, embodiments disclosed herein relate to using solenoid valves with instrumentation enclosures to control fluid flow in hazardous areas. Embodiments disclosed herein are described further with respect to the following drawings.

FIG. 1 shows a solenoid valve in accordance with one or more embodiments disclosed herein.

FIGS. 2A-2B show examples of a 6-way valve manifold assembly in accordance with one or more embodiments disclosed herein.

FIG. 3 shows a flow chart for retrofitting an improved solenoid valve in accordance with one or more embodiments disclosed herein.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments disclosed herein provide a method and apparatus for general purpose solenoid valves to operate to control fluid/gas flow in hazardous areas. More specifically, embodiments disclosed herein incorporate the electrical parts of the general purpose solenoid valves into a pressurized instrumentation enclosure to achieve safety in the hazardous area, while the fluid handling parts of the valve are kept outside the instrumentation enclosure.

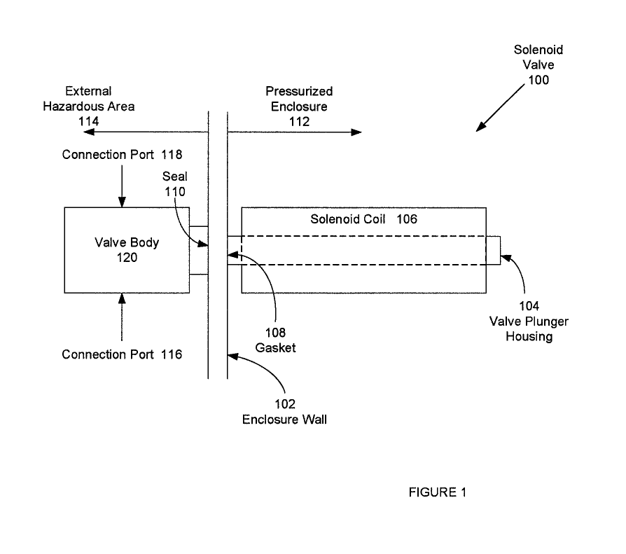

FIG. 1 shows a solenoid valve (100) in accordance with one or more embodiments disclosed herein. Specifically, FIG. 1 shows a solenoid valve (100) operating in an external hazardous area (114). In one or more embodiments, the solenoid valve (100) may be a two port, normally closed general-purpose solenoid valve.

The solenoid valve (100) includes a valve plunger housing (104) and a valve body (120). In one or more embodiments disclosed herein, the aforementioned two portions of the solenoid valve (100) are separated by an enclosure wall (102) of an instrumentation enclosure (112) that operates in hazardous area (114). In one or more embodiments disclosed herein, the instrumentation enclosure may be, but is not limited to, a sample handling system, a gas analyzer, or any other type of suitable gas conditioning equipment. In one or more embodiments, the instrumentation enclosure (112) may be pressurized with a non-flammable fluid/gas. The enclosure wall (102) separating the external hazardous area (114) and the pressurized instrumentation enclosure (112) may be made of mild steel, stainless steel, or any other suitable material. The grade of the stainless steel may vary to be compatible with the environment of the instrument enclosure. Further, the enclosure wall (102) may be lined (e.g., painted) with another material to prevent direct contact between the enclosure wall (102) and the valve body (120) and/or the valve plunger housing (104) of the solenoid valve and to prevent corrosion.

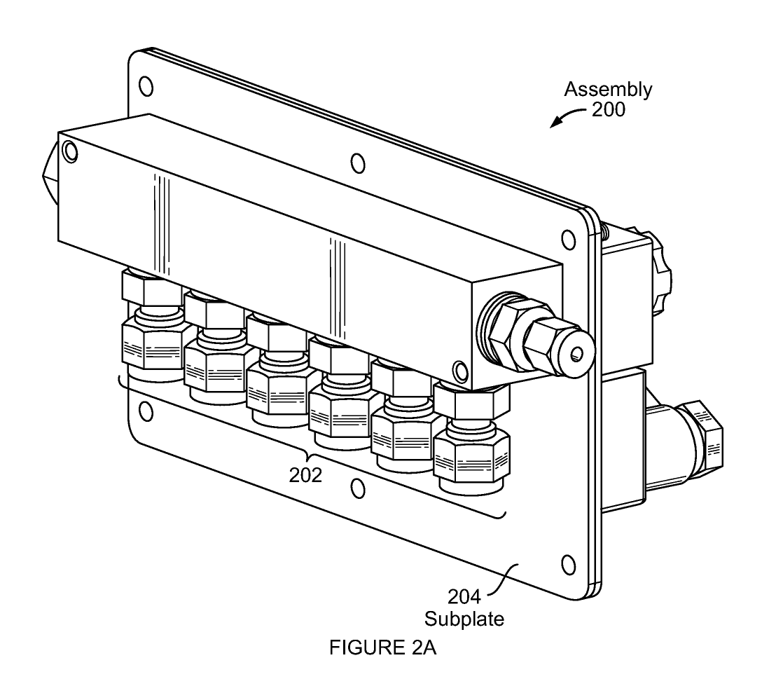

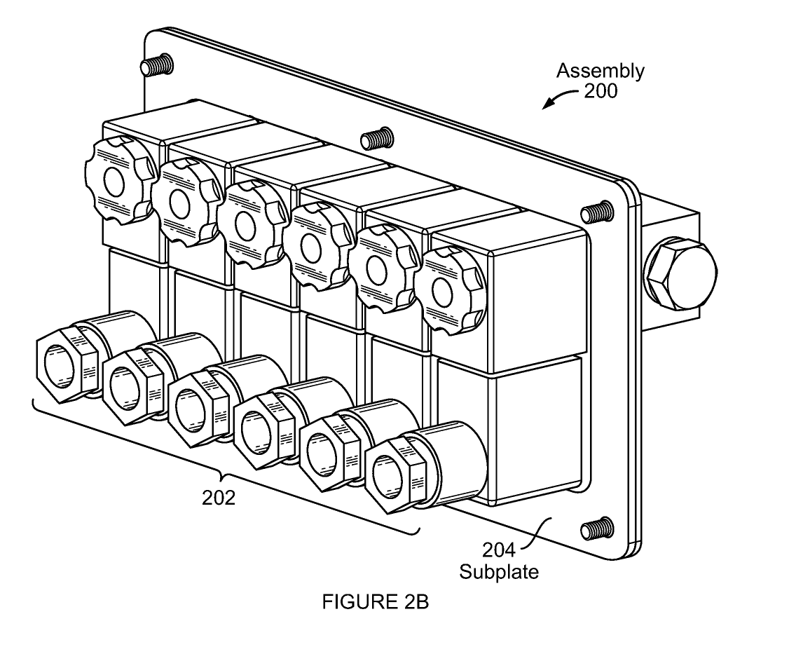

The minimum thickness of the enclosure wall (102) may be compliant with the regulations in force governing the mechanical strength of a pressurized and purged enclosure and may depend on the enclosure size. In one or more embodiments, the minimum thickness of the enclosure wall (102) may be 1 mm. The maximum thickness of the enclosure wall (102) may be 4 mm. In one or more embodiments disclosed herein, the thickness of the enclosure wall may impact the coil-to-valve separation. When this is a problem, the valve(s) may be mounted on a thinner sub-plate that in turn is sealed to the enclosure wall (102). FIG. 2A shows an example of a sub-plate (204) for use with a 6-way valve manifold (202), and the assembly (200) for the sub-plate (204). FIG. 2B shows another view of a 6-way valve manifold (202), and the assembly (200) for the sub-plate (204).

In one or more embodiments disclosed herein, the enclosure wall includes an aperture (not shown) through which the valve plunger housing is inserted, so that one portion of the solenoid valve (100) (i.e., the valve plunger housing (104) and associate solenoid coil (106)) is located within the pressurized enclosure (112) while another portion of the solenoid valve (100) (i.e., the valve body (120)) is located outside the pressurized enclosure (112) in the hazardous area (114).

The valve body (120) includes all the connection ports (116, 118) for controlling fluid flow. The valve plunger housing (104) includes a solenoid coil (106) wound around the valve plunger housing (104). In one or more embodiments of the invention, the valve plunger housing (104) is machined from a single piece of metal and/or is a welded assembly. In the case of a welded assembly, the assembly also adheres to the requirements of infallibility described in the BSI standard document EN 60079-2, which specifies the level of safety requirements for a specific hazardous area.

In one or more embodiments disclosed herein, a gasket (108) (or other type of seal) may be disposed between the valve plunger housing (104) and the enclosure wall (102). The gasket (108) may be used to fill any gaps that may remain between the valve plunger housing (104) and the enclosure wall (102). Similarly, a seal (110) may be disposed between the valve body (120) and the enclosure wall (102). The seal (110) may be placed to close any gaps that may be present between the enclosure wall (102) and the valve body (120). In one or more embodiments, the seal (110) may be an O-ring. The gasket (108) and the seal (110) may thereby prevent leakage between the enclosure wall (102) and respective portions of the solenoid valve (100).

Those skilled in the art will appreciate that while FIG. 1 shows only a single solenoid valve, embodiments disclosed herein may be implemented using multiple solenoid valves operatively connected to each other in a manifold (not shown). In this case, each of the solenoid valve in the manifold may be a valve such as that described above with respect to FIG. 1.

Using a solenoid valve such as the one shown in FIG. 1, embodiments of the invention provide a method that allows for general purpose solenoid valves to be used in hazardous area. Specifically, the method incorporates the electrical parts of the solenoid valve (i.e., the solenoid coil and associated connections) within the pressurized instrumentation enclosure to achieve safety in the hazardous area, while the fluid handling parts (i.e., one or more connection ports on the valve body of the solenoid valve) are placed outside the instrumentation enclosure in the hazardous area. In one or more embodiments disclosed herein, the method involves controlling fluid flow using the solenoid valve by supplying an electrical current to the solenoid coil. The electrical current is converted by the solenoid valve to mechanical energy, which mechanically opens and/or closes the fluid connection ports on the valve body of the solenoid valve.

Further, the method may involve pressurizing the instrumentation enclosure using non-flammable fluids/gases. For example, in one or more embodiments disclosed herein, compressed air may be used to pressurize and purge the instrumentation enclosure to prevent ignition of the solenoid coil and associated connections within the instrumentation enclosure. In other embodiments, inert gases, such as Nitrogen, Argon, Krypton, or other suitable non-flammable gases may be used.

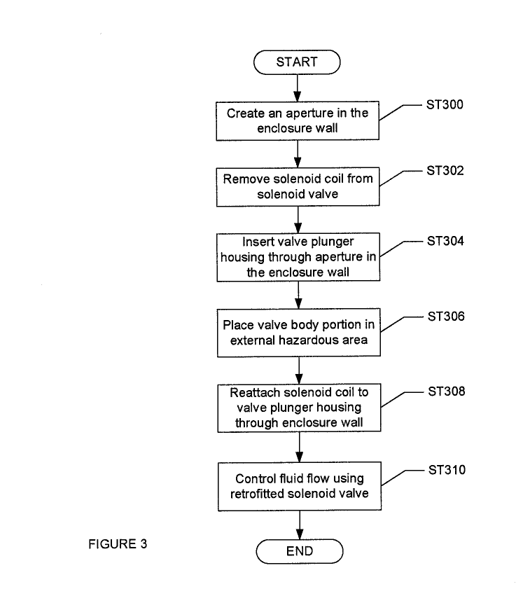

FIG. 3 shows a flow chart for retrofitting a solenoid valve for operation in a hazardous area in accordance with one or more embodiments disclosed herein. Retrofitting the solenoid valve involves taking the solenoid valve apart and re-fitting the valve through an enclosure wall of an instrumentation enclosure. While the various steps in the flow chart of FIG. 3 are presented and described sequentially, one of ordinary skill will appreciate that some or all of the steps may be executed in different orders, may be combined or omitted, and some or all of the steps may be executed in parallel.

Initially, an aperture is created in the enclosure wall of the instrumentation enclosure (ST300). The aperture may be created by using any suitable tool to punch a hole into the enclosure wall. Subsequently, the solenoid coil is removed from the solenoid valve (ST302). More specifically, the solenoid coil is on a former, i.e., a potted and sealed unit. The coil is removed as a single intact entity. Next, the valve plunger housing is inserted through the aperture created into the enclosure wall (ST304). Specifically, the valve plunger housing is inserted from outside the instrumentation enclosure into the instrumentation enclosure. In one embodiment of the invention, when the valve plunger housing is inserted through the aperture, the valve plunger housing is placed inside the pressurized enclosure, while the valve body of the solenoid valve remains outside the instrumentation enclosure, in the hazardous area (ST306).

In one or more embodiments disclosed herein, although not shown in FIG. 3, during retrofitting of the solenoid valve, there may be seals/gaskets inserted on both sides of the enclosure wall to eliminate gaps and prevent leakage between both the valve plunger housing and the enclosure wall and the valve body and the enclosure wall.

At this stage, the solenoid coil is reattached to the valve plunger housing within the instrumentation enclosure (ST308). Upon reassembly of the solenoid valve through the enclosure wall, the solenoid valve may be used to control fluid flow as described above (ST310). Controlling fluid flow may involve supplying an electrical current to the solenoid coil, which is then converted to mechanical energy used to open/close the connection ports in the valve body of the solenoid valve. In addition, controlling fluid flow may also involve pressurizing the instrumentation enclosure by filling the enclosure with a non-flammable fluid/gas.

Those skilled in the art will appreciate that the process described above may be repeated for multiple solenoid valve in a manifold or when a single solenoid valve is replaced with another solenoid valve. Further, those skilled in the art will appreciate that, because the process of retro-fitting the solenoid valve involves removing the coil from the valve, the solenoid valve must be able to tolerate any valve-to-coil spacing changes that may occur when the solenoid coil is removed and reassembled through the enclosure wall. That is, any valve-to-coil spacing changes made by the retro-fitting of the solenoid valve must not affect the functionality of the valve. This may be one of the considerations involved when selecting a type of solenoid valve to use in embodiments disclosed herein.

Embodiments disclosed herein provide for general purpose solenoid valves to be used, in conjunction with a pressurized instrumentation enclosure, in hazardous areas. The use of general purpose solenoid valves to control fluid flow in hazardous areas provides significant savings in costs, complexity, and space requirements.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An apparatus for controlling fluid flow, comprising:
a solenoid valve, comprising:
a valve body located outside an instrumentation enclosure, wherein the valve body comprises at least one connection port for controlling fluid flow,
a valve plunger housing located within the instrumentation enclosure, wherein a solenoid coil is wound around the valve plunger housing portion; and
an instrumentation enclosure wall comprising an aperture through which the valve plunger housing is inserted into the instrumentation enclosure.

2. The apparatus of claim 1, wherein the instrumentation enclosure operates in a hazardous area.

3. The apparatus of claim 1, wherein the solenoid coil is removable from the valve body portion of the solenoid valve.

4. The apparatus of claim 1, further comprising:
a gasket disposed between the instrumentation enclosure wall and the valve plunger housing.

5. The apparatus of claim 1, further comprising:
a seal disposed between the instrumentation enclosure wall and the valve body.

6. The apparatus of claim 1, wherein the valve plunger housing comprises a welded assembly.

7. The apparatus of claim 1, wherein the valve plunger housing is machined from a single piece of solid metal.

8. The apparatus of claim 1, wherein the solenoid valve is a two port, normally closed valve.

9. The apparatus of claim 1, wherein the instrumentation enclosure is one selected from a group consisting of a gas analyzer and a fluid handling system.

10. The apparatus of claim 1, wherein the solenoid valve is one of a plurality of solenoid valves in a manifold.

11. The apparatus of claim 1, wherein the instrumentation enclosure is pressurized using compressed air.

12. The apparatus of claim 1, wherein the instrumentation enclosure is pressurized using at least one of nitrogen and argon.

13. A method for using a solenoid valve in a hazardous area comprising an instrumentation enclosure, the method comprising:
controlling fluid flow using the solenoid valve, wherein the solenoid valve comprises:
a valve body located in the hazardous area, and
a valve plunger housing around which a solenoid coil is wound,
wherein the valve body comprises at least one connection port for controlling fluid flow and is located outside the instrumentation enclosure in the hazardous area, and
wherein the valve plunger housing and the solenoid coil are located within the instrumentation enclosure.

14. The method of claim 13, wherein controlling fluid flow comprises:
supplying an electrical current to the solenoid coil, wherein the electrical current is configured to mechanically open and close the at least one connection port in the valve body of the solenoid valve.

15. The method of claim 13, wherein controlling the fluid flow comprises:
pressurizing the instrumentation enclosure using a non-flammable fluid.

16. The method of claim 13, wherein the solenoid valve is a two port, normally closed valve.

17. A method for retrofitting a solenoid valve comprising a valve body portion and a valve plunger housing portion around which a solenoid coil is wound, to operate in a hazardous area comprising an instrumentation enclosure, the method comprising:
creating an aperture in an enclosure wall of the instrumentation enclosure;
removing the solenoid coil from the solenoid valve;
reassembling the solenoid coil through the enclosure wall, wherein reassembling the solenoid coil through the enclosure wall comprises:
inserting the valve plunger housing portion through the hole of the enclosure wall,
placing the valve body portion outside the instrumentation enclosure in the hazardous area, and
reattaching the solenoid coil to the valve plunger housing portion located inside the instrumentation enclosure.

18. The method of claim 17, further comprising:
inserting a first seal configured to seal a space between the enclosure wall and the valve plunger housing portion.

19. The method of claim 17, further comprising:
inserting a second seal configured seal a space between the enclosure wall and the valve body portion.

20. The method of claim 17, further comprising:
controlling fluid flow using the valve body portion of the solenoid valve located in the hazardous area.

21. The method of claim 20, wherein controlling fluid flow comprises:
supplying an electrical current to the solenoid coil, wherein the electrical current is configured to mechanically open and close the at least one connection port in the valve body of the solenoid valve.

22. The method of claim 20, wherein controlling the fluid flow comprises:
pressurizing the instrumentation enclosure using compressed air.
